(19) United States
(12) Patent Application Publication
(10) Pub. No.: US 2004/0247995 A1
(43) Pub. Date: Dec. 9, 2004

(54) Electrical storage battery

(76) Inventor: John L. Devitt, Denver, CO (US)

Correspondence Address: SHERIDAN ROSS PC, 1560 BROADWAY, SUITE 1200, DENVER, CO, 80202

(21) Appl. No.: 10/863,158

(22) Filed: Jun. 7, 2004

Related U.S. Application Data
(60) Provisional application No. 60/477,273, filed on Jun. 9, 2003.
(60) Provisional application No. 60/493,122, filed on Aug. 6, 2003.

(51) Int. Cl. H01M 2/02; H01M 2/08

(52) U.S. Cl. 429/66; 429/164; 429/185

(57) ABSTRACT

The present invention relates generally to devices that are adapted to store energy. More specifically, one embodiment of the present invention is a battery that employs a plurality of compartments which hold cell elements that generate electricity through an electrochemical reaction. In addition, one embodiment of the present invention employs arcuate end compartments that are adapted to hold a non-compressible fluid that aids in the reaction of internal pressure loads generated by the electrochemical reaction. This fluid in one embodiment may be put in compression during manufacturing of the battery. Thus, the present invention enables the internal compartment walls to impart sufficient compression on the cell elements to enhance the battery's efficiency and useful life.

This application claims the benefit of U.S. Provisional Application Ser. No. 60/477,273, filed Jun. 9, 2003, and U.S. Provisional Application Ser. No. 60/493,122, filed Aug. 6, 2003, both applications being incorporated by reference in their entirety herein.

### FIELD OF THE INVENTION

The present invention generally relates to electric storage batteries and electrochemical supercapacitors that are capable of selectively storing and discharging electrical energy, such as lead-acid batteries, alkaline batteries utilizing nickel oxide positive electrodes and lithium-ion batteries.

### BACKGROUND OF THE INVENTION

Batteries are usually comprised of at least a prismatic housing, which further includes a number of compartments that each hold individual electricity producing cell elements. The individual cells are connected to yield a battery that provides electrical current. A common example of the art is a 12-volt lead-acid car battery that includes an injection molded plastic housing divided by partitions into six cell compartments.

Generally, prismatic batteries employ electrochemical cell elements whose components are in sheet form, wherein planar positive and negative plate electrodes sandwich permeable separator sheets. The plates and separators reside in compartments that are filled with an electrolyte, wherein an electrochemical reaction generates current that is channeled to the terminals of the battery. In particular, many contemporary battery cells use absorbent separators that retain substantially all of the liquid electrolyte within their porous structure. It is essential that the components of this type of cell are held in intimate contact by at least a mild compressive force during the life of the battery. Sub-optimal contact may reduce the cell's power generating capacity, increase its internal resistance, and consequently increase heating within the cell, thus shortening the operating life of the battery.

Generally, prismatic batteries are composed of a plurality of individual compartments that accommodate electrochemical cell elements. These compartments are formed within an outer housing by partitions that completely separate one cell from the one adjacent to it, except for electrical connections that conduct current between cells and to and from the terminals. The required axial pressure needed to maintain contact between electrode plates and absorbent separators must be furnished by the flexural strength of compartment walls, and ultimately the end walls of the battery.

Prismatic batteries of the prior art have historically suffered from inadequate levels of compression between adjacent cell components. In addition, many contemporary prismatic batteries do not vent the gases produced during the latter stage of battery charging, but instead allow the oxygen produced at the positive plates to diffuse through the incompletely-saturated porous separator to reach the negative plates. An example of this phenomenon is found in valve-regulated lead-acid batteries. There, the oxygen reacts with the sponge lead on the negative plate, and sulfuric acid to form water and lead sulfate. During charging some oxygen pressure rise occurs in order to force this reaction. The pressure reaches an equilibrium controlled by the charging current level and the rate of the reaction. It is very beneficial for the battery to be able to sustain a sizeable charging current, in many of its uses, and thus the ability to maintain a corresponding internal gas pressure is also beneficial. The gas produced exerts a pressure on the compartment walls thereby deflecting them and thus reducing or even eliminating the contact between the plates and separators. Moreover, batteries may experience substantial outward bulging of the end walls, thus shortening the life and performance of the system. In addition, the electrodes may expand during the life of the battery, which may add to housing deformation. Accordingly, batteries often employ a pressure relief valve for each compartment to prevent over pressurization.

Alternatively, battery cells may also be constructed in a cylindrical shape, wherein the electrodes and separators are wound together in a spiral configuration. If the winding is tight, the pressure between electrodes and separators is assured. Thus, the cylindrical container is probably the ideal shape for compression containment, as long as the cylinder wall is capable of withstanding the hoop stress needed to maintain the internal element compression.

Thus, a battery comprised of a series of electrically interconnected cylindrical batteries may be constructed, such as in the shape of a six-pack of beverage containers. The present superiority of the cylindrical cell construction is clearly evidenced by such commercial products as the Optima® automotive battery, manufactured presently by Johnson Controls, Inc., Milwaukee, Wis. This product frequently shows a working life in a car significantly beyond its six-year warranty, which is a far-longer lifetime than usually found in batteries that employ flat plates and prismatic containers. A principal reason for its longevity is the continuing control of cell element compression by the superior hoop strength of the cylindrical walls of the cell housings. However, a battery composed of this array of cylindrical cells occupies a larger overall volume than does a flat plate prismatic battery having the same electrical performance. Further, large cylindrical-cell batteries have proven to be considerably more expensive to manufacture than flat-plate batteries.

Many attempts have been made to eliminate end wall weakness and deflection. For example, U.S. Pat. No. 5,492,779 to Ronning discloses the use of ribs molded integrally in the plastic end wall in an attempt to raise the flexural strength of the wall. However, it has been generally observed that, particularly in high-temperature use, these reinforced end walls gradually bulge outward, thus no longer retaining cell compression. In addition, U.S. Pat. No. 4,729,933 to Oswald discloses an additional compartment situated outboard of the compartments and operating at the same internal pressure as the compartments. This structure provides some relief from the problem of internal gas pressure, but cell element compression still depends upon the flexural strength of a flat partition to provide compression to the cells, which may not be adequate. U.S. Pat. No. 5,958,088 to Vu, et al. discloses a cell container having faces of matching curvature, one concave and one convex. This structure provides improved compression but requires that the cell element be made of curved sheets. There are, unfortunately, few electrodes in contemporary use that can be curved economically. In addition, the thick electrodes used in many batteries cannot be economically curved. U.S. patent Nos. that describe the scope of the art are: U.S. Pat. Nos. 5,492,779, 4,729,933, 5,958,088, and 3,862,861 and are incorporated by reference in their entirety herein.

Thus, there is a long felt need in the field of electrical energy storage to provide a cost-effective battery that maintains the internal pressure imparted on cell elements therein, without greatly affecting the overall volume of the battery. The following disclosure describes an improved battery that includes a housing that controls and maintains the internal axial pressure on the battery components therein. It is thus one aspect of the present invention to eliminate the need in a prismatic battery to rely solely on the flexural strength of the end walls to maintain this axial compression, as is done in prior art batteries. Instead, the invention utilizes the tensile strength of cylindrically-arcuate end walls as part of a compartment that in one embodiment contains a combination of an incompressible liquid and a gas to achieve long-term control over the axial compression of cell elements in the prismatic battery.

### SUMMARY OF THE INVENTION

It is thus one aspect of the present invention to provide an electrical energy storage device (hereinafter “battery”) that is capable of storing and selectively discharging said energy. One embodiment of the present invention includes at least a cathode, an anode, and a housing. More specifically, the housing preferably includes a plurality of compartments adapted to hold positive and negative plate-type electrodes that sandwich permeable separator materials that allow current to pass therebetween. The compartments are also adapted to hold an electrolytic fluid that participates in the electrochemical reactions involved in discharging and charging the battery.

It is another aspect of the present invention to provide a battery housing that employs at least one additional compartment that is adapted to help maintain pressure inside the battery. The aforementioned electrode sandwiches are the most efficient when intimate contact between the electrodes and permeable material is maintained. In normal battery operations, gas is often produced that typically deforms the battery housing, thus reducing or eliminating the intimate contact. One embodiment of the present invention employs additional end compartments each having an arcuate wall and distinct geometric configuration to prevent the deflection of battery end walls. In one embodiment the end compartments are substantially filled with a substantially incompressible liquid. When the compartment is predominately filled with the liquid, allowing only a small gas space for thermal expansion compensation, the compartment acts as a solid wall, wherein pressure loads emanating from the internal compartments will be reacted by the liquid, and arcuate wall, and thus the shape of the end cell compartments will be substantially maintained.

In one embodiment the liquid in the compartments is resistant to freezing, but an additional air-filled space is provided in the liquid compartment to accommodate any expansion of the liquid. Thus, care must be taken when filling the compression compartment to leave a small air space. Thermal expansion coefficients for the container (linear) and liquid (bulk) will vary depending upon the material choices made for the final design. Thus, the possibility for the compression compartment to rupture due to hydraulic pressure caused by temperature changes encountered by the battery during either storage or use is greatly eliminated. The preferred procedure is simply to experimentally observe the results of temperature changes applied to test battery containers and fill liquids and ascertain the needed air space. The smallest air space that will, with certainty, prevent container rupture, is the preferred one to use. Larger air spaces will cause unwanted compressibility to occur. In addition, the temperature that the filling operation is performed should be controlled.

It is another aspect of the present invention to provide complete retention of the compression generated within the cells of a prismatic battery by using the cylindrical shape of the end walls to prevent flexure of the inner flat cell walls. Thus, an additional convex end wall is added to each end of an otherwise conventional battery. This added arcuate wall has the curved shape of a right-circular cylinder that is commonly employed in ordinary pressurized tanks. The space between the flat, end cell wall and the cylindrical wall is substantially filled with a substantially incompressible liquid, or equivalent material. Assuming an adequate tensile strength in the cylindrical wall, it will not move significantly under pressure and the liquid will not move nor compress, and thus the flat cell wall contacting the liquid and the other cell compartment partitions in the battery will not deflect. Thus, compression within the cells is permanently maintained. In addition, an initially high cell compression that is preferred in some types of batteries is easily achieved, but is impossible in a prior art battery having flat end walls.

A key parameter in designing the compression compartment is the radius of curvature of the cylindrical end wall. An unduly small radius will cause an appreciable increase in overall battery length, which is generally undesirable. The ideal shape for the end wall is that of a geometrically-defined “right circular cylinder”. This shape will not distort or move under pressure if the enclosing material is substantially non-elastic, as is battery container material. The safely allowable minimum radius of curvature of this end wall is preferably calculated as follows:

Stress (S) in curved, end wall,

$$\text{in psi} = \frac{PR}{T}$$

where: P=internal pressure in compression compartment, in psi;

R=radius of curvature, in inches;

T=thickness of cylindrical end wall, in inches.

Assuming a typical injection-molded plastic battery housing, it is preferred to obtain allowable levels of stress in the plastic material of the end wall, considering the molding process parameters and the expected storage and operating temperatures for the battery, from the manufacturer of the container plastic material. The internal pressure to be expected in the compression compartment, as caused by gas pressure and element expansions, with the latter based upon the experience of the battery manufacturer, is used in the above expression. For example, a typical value might be 10 psi (69 kPa). An example of a typical end wall thickness in an automotive battery is 0.1 inches (2.54 mm). If a plastic material allowable stress value of 2,500 psi (17,240 kPa) is assumed, the resulting radius of curvature will be 25 inches (63.5 cm). For a battery seven inches (17.8 cm) wide this curvature results in only about a 0.75-inch (1.9 cm) increase in overall battery length. In a particular housing design, the radius of curvature and the arcuate wall thickness are the variables that are adjusted in the above formula to give an optimum result.

There are a number of possible materials that are substantially non-compressible, and which can be placed within the compression compartments. In one embodiment, the non-compressible filler material will possess the following attributes:

1. It must not dissolve or react with the container and cover material;

2. It should not freeze or boil over the range of storage and operating temperatures to be seen by the battery;

3. It should be an excellent thermal conductor in order to conduct heat generated by the battery to the outside during its operation;

4. In the event of a leak, either to the battery exterior or to a cell element, it must be relatively benign and not interfere with battery performance; and

5. It should not impose an unreasonable weight penalty.

Some materials that have been identified that meet the above-listed requirements include purified mineral oil, salt solutions, and battery electrolyte. In the case of the lead-acid battery the preferred sulfuric acid concentration of an electrolytic filler is one that freezes at about −40° C., or about 32 percent sulfuric acid by weight. Acids used in the battery cells are also satisfactory, although they weigh slightly more. Alkaline batteries generally use potassium hydroxide electrolyte in a concentration range between about 30 and 45 percent by weight, which would be preferred compression compartment liquids for nickel-cadmium and similar batteries. In addition, oils, waxes, and closed-cell foams would generally perform well as compression materials, but they have poor thermal conductivity. For example, petroleum oils generally show a thermal conductivity only about one-fourth that of battery electrolyte, and waxes and foams have even lower thermal conductivity.

It is yet another aspect of the present invention to provide additional structural features that are integrated into the end compartments, such as ribs, gussets, webs, or struts, in place of the non-compressible liquid.

It should be noted that batteries that are constructed with axial compression applied to the cell elements during insertion into the battery housing may require a modification to the present invention. More specifically, since these elements are compressible, and are elastic, they will expand axially once they are in place in the housing. The partitions defining the cell compartments then will assume a slightly convex shape, bowing toward the ends of the battery. In order to re-establish the required control over the compressed condition of the cell elements, the compression compartments at the ends of the battery are filled with liquid under pressure. This causes the cell compartment partitions to resume their planar shape and place the cell elements under the intended axial pressure.

In the manufacturing sequence, the cell elements are placed in their compartments and electrically interconnected. The battery cover is then sealed onto the housing. The slight bowing of partitions is accommodated and corrected in the conventional cover attachment process commonly known in the art, wherein triangular guide tabs in the cover locate the partitions in alignment with the mating surfaces on the underside of the cover. Pressurized liquid fill is then applied to the compression compartments. First, the compartments are nearly filled by simply pouring the liquid in. Then, a check valve is fitted into the opening of each compression compartment and air is introduced through each valve to obtain the required static pressure level. It has been identified through experimentation that the optimum pressure required in valve-regulated lead acid batteries is in the range of about 4 to 12 psi, and more preferably about 10 psi.

In a battery of the present invention that includes pressurized compression compartments, the ability to control cell element compression is available as provided herein. More specifically, three variables may be changed to provide a wide variety of inelastic or elastic responses by the compression compartment to cell element swelling or shrinkage:

1. Compression compartment volume may be increased by reducing the radius of curvature of the end wall, or by inserting a straight wide wall increment between the adjacent cell partition and the end wall. 2. The liquid fill level may be reduced, yielding a greater amount of elasticity because of the increased gas volume. 3. The final, as manufactured, compression compartment internal pressure may be varied as needed by adjusting the amount of gas placed in the compartment.

As described above, a substantially solid wall is provided to the cell compartments when the gas volume is only large enough to provide protection against thermal expansion effects. Thus, the compartment is nearly completely filled with liquid. At the other extreme, the fill material consists predominantly of gas, providing the maximum amount of elasticity. However, it is readily seen that this situation is superior to that in which the battery end wall is a simple flexible member, as in conventional prior art batteries. If, for example, the compression compartment is relatively large, small deflections of its “flat” partition, the cell elements next to the adjacent cell element, will cause only a very small change in the cell element's internal pressure, and the compression compartment partition will allow either an expansion or shrinkage of the cell element, maintaining a nearly constant force against the element. This significant improvement does not occur in prior art batteries.

Notwithstanding the above description, an “all-gas” fill is the less-preferred embodiment in the case where it is desired to dissipate heat from the cells, because of the poor thermal conductivity of the gas. Rather, it has been found that a useful alternative is a liquid fill to a level corresponding to about the level of the plate tops in the cell elements. In a typical battery design this still provides a substantial amount of gas volume, but still allows for acceptable heat transfer through the liquid.

It is another aspect of the present invention provide a check valve fitted to the compression compartment similar to that employed in an ordinary valve stem on a tire. This allows the internal pressure in the compression compartment to be checked or altered during the operating life of the battery.

Although most embodiments of the compression compartment employ a cylindrical end wall, the advantages of the pressurized fill of the compartment are obtained even if the battery end wall is an alternative design using flexural strength to retain the pressure. Examples of this are walls employing molded-in ribs, and stiff metal plates added to the battery end wall.

It is yet another aspect of the present invention to provide compression compartment cover that utilizes an O-ring seal for improved retention of gas or liquid pressure. This design also provides an additional advantage in that the compression compartment may be pressurized prior to the attachment of the main battery cover. This places all of the partitions in their final positions and enhances the accuracy of the cover attachment process, such as heat sealing.

It is a further aspect of the present invention to provide an adapter that may be installed on existing batteries that do not employ arcuate end compartments of the present invention. More specifically, one embodiment of the present invention includes two end compartments that are operably interconnected to each other. This embodiment can be easily interconnected to an existing battery, whereby pressures developed within it are transferred directly to the two compression compartments of the attached adapter. If a pressurized liquid or gas fill is used in these compression compartments they may be interconnected to the battery housing prior to being filled.

It is still yet another aspect of the present invention to provide a support mechanism that is adapted to be used with the present invention. More specifically, a support shroud is provided that fits over the battery employing arcuate end walls to increase external support. The shroud is designed for selective interconnection to the battery of the present invention, and allows the user to selectively increase the support by adjusting an attachment device, such as a screw, bolt, ratchet, clasp, buckle, etc.

It is also an aspect of the present invention that it be inexpensive to manufacture and constructed from materials known in the art. The housing of the present invention is constructed from material compatible with the battery chemistry. For example, polypropylene plastic is preferred for acid electrolyte batteries and nylon is preferred for alkaline electrolyte batteries.

The present invention is also applicable to fuel cells and electrolytic capacitors of the type generally known as electrical double layer supercapacitors or ultracapacitors. These capacitors employ electrodes composed of porous materials having an extremely high surface area in contact with an electrolyte. The porous material may be the same for both electrodes. In addition, either electrode may use double layer charge storage, or Faradaic pseudocapacitance charge storage. One skilled in the art will appreciate that the present invention applies equally to fuel cells and capacitors.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these embodiments.

FIG. 1 is a front perspective view of one embodiment of the present invention that employs arcuate end compartments;

FIG. 2 is a front perspective view of the invention shown in FIG. 1, wherein selected portions are removed for clarity to show a plurality of compartments;

FIG. 3 is a top plan view of the invention shown in FIG. 1, wherein a cover is removed for clarity to show the electrochemical cell elements in their compartments;

FIG. 4 is a partial top plan view of an alternate embodiment of the present invention, that employs end compartments to provide additional structural support;

FIG. 5 is an alternate embodiment of the present invention, wherein arcuate end compartments are attachable to an existing conventional battery;

FIG. 6 is a perspective view of a reinforcing shroud for the battery of FIG. 1;

FIG. 7 is a front partial cross section of a filler hole closure of the present invention;

FIG. 8 is a partial front cross section of a compression compartment liquid filler hole which contains a removable check valve;

FIG. 9 is a front cross section of the sealing area of a separate compression compartment cover, together with details of triangular guide tabs located on the cover on the housing; and

FIG. 10 is a top view of an alternative compression compartment shape.

To assist in the understanding of the present invention the following list of components and associated numbering found in the drawings is provided herein:

| # | Component |
|---|---|
| 1 | Battery |
| 2 | Terminal |
| 4 | Electrolyte Filler Hole |
| 6 | Valve Cover |
| 8 | Primary Cover |
| 10 | Liquid Filler Aperture |
| 12 | Curved End Wall |
| 14 | Battery Housing |
| 16 | Side Wall |
| 18 | Partition |
| 20 | Compression Compartment |
| 22 | Cell Element Compartment |
| 24 | Cell Element |
| 26 | Electrical Connection |
| 28 | Stiffening Member |
| 30 | Interconnecting Member |
| 32 | Boss |
| 34 | Slot |
| 36 | Cap |
| 38 | Filler Hole Boss |
| 40 | Removable Check Valve |
| 42 | Check Valve Rubber Ball |
| 44 | Check Valve Spring |
| 46 | Separate Compression Compartment Cover |
| 48 | O-ring, shown in section |
| 50 | Triangular Locating Tab in Cover |
| 52 | Ultrasonic Spot Weld |
| 54 | Final Cover Heat Seal |
| 56 | Straight Section in Compression Compartment |
| 58 | Radiused Inner Corner |

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

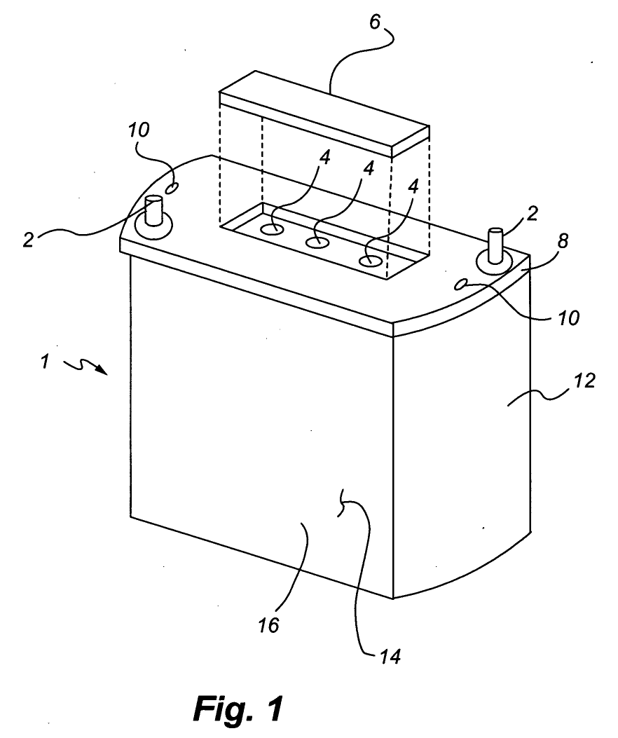

Referring now to FIGS. 1-10, a battery 1 that is equipped with arcuate end walls 12 is shown herein. More specifically, in one embodiment of the present invention, a battery is provided that comprises arcuate end walls 12 that define a compression compartment 20, wherein non-compressible fluid is added. This fluid acts to maintain a pressure, wherein the cell elements 24 are maintained at a predetermined compression, thereby ensuring that the battery life is increased.

Generally, the battery 1 is constructed of a housing 14, a cover 8, two terminals 2 positioned therethrough, a plurality of holes 4, 10 wherein pressure may be released or fluid may be added to the battery system. The housing 14 further includes a plurality of compartments 22, wherein battery cell elements 24 are housed. The cell elements 24 of the present invention generally include electrodes that sandwich a generally permeable separator material, which together with electrolytic fluids within the compartment, create electric current.

Referring now to FIG. 1, one embodiment of the battery of the present invention is shown herein. The battery 1 generally includes a housing 14, a cover 8, and terminals 2 that protrude through the cover 8. Typically, the battery cells each include an electrolyte filler aperture 4 for interconnection to a pressure relief valve and associated cover 6. The main battery cover 8 contains two additional apertures 10 above the two compression compartments 20. After the cover 8 has been interconnected to the container, a substantially non-compressible liquid is added to the compression compartments through filler apertures 10, nearly filling them. The filler apertures 10 are then permanently sealed.

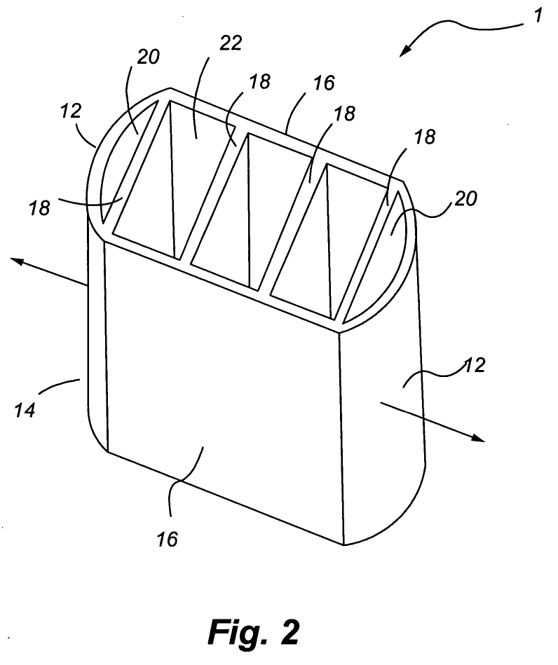

Referring now to FIG. 2, the housing 14 of the present invention is shown herein. One embodiment of the present invention employs a housing 14 that further includes a plurality of compartments 22 used to hold electrochemical cell elements. The end compartments 20 are generally arcuate, employ a flat internal partition and an arcuate external wall, and contain an incompressible liquid that transfers internal pressures developed within the electrochemical cell elements directly to the arcuate wall, placing it in tensile stress. The top edges of end walls 12, side walls 16, and partitions 18 lie in the same plane in order for the cover attachment seal to be leakproof, since leaks in the compression compartments will eliminate their ability to maintain compression within the battery.

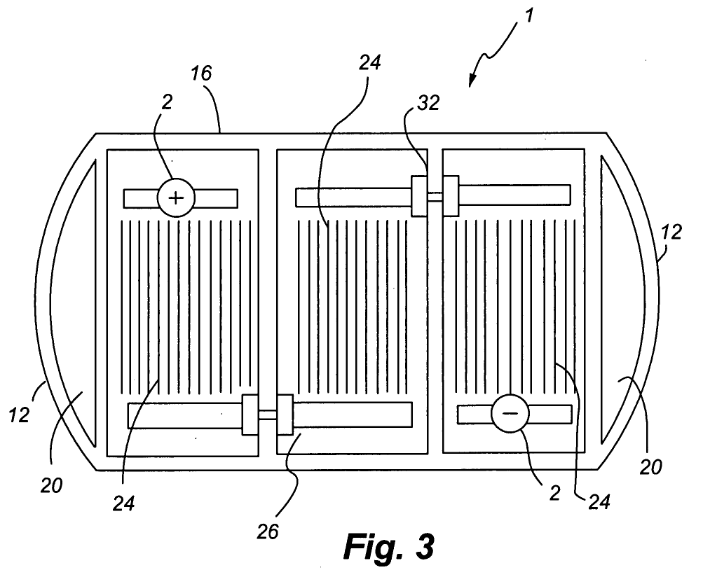

Referring now to FIG. 3, the electrochemical cell elements 24 as installed in the battery are shown herein. These elements are electrically linked by connectors 26, wherein the end-most cells are electrically connected to the battery terminals 2. One embodiment of the present invention is shown, wherein the battery contains three cells. However, as it will be appreciated by one skilled in the art, the present invention may be scaled to any size and any number of cells may be used to achieve a specific result.

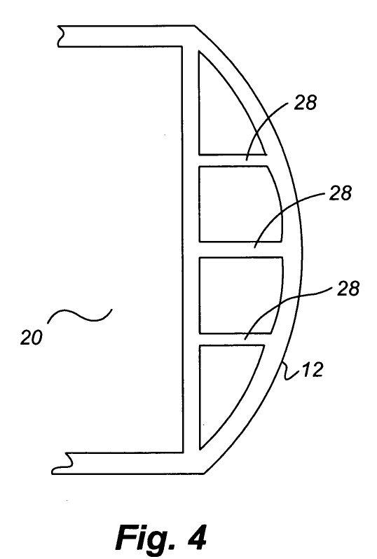

Referring now to FIG. 4, an alternative embodiment of the present invention is shown herein. More specifically, another embodiment of the compression compartment 20 is shown wherein a plurality of stiffening members 28 are employed that are molded integrally into the housing structure and oriented perpendicularly to the electrode plates. However, when this structure is employed as an alternative to the use of a incompressible liquid, because the poor heat transfer from the battery cells to the external arcuate wall is a disadvantage. Stiffening members 28 as shown herein are easily adapted to be molded with the battery housing, or alternatively, the compression compartment 20 may be machined therein.

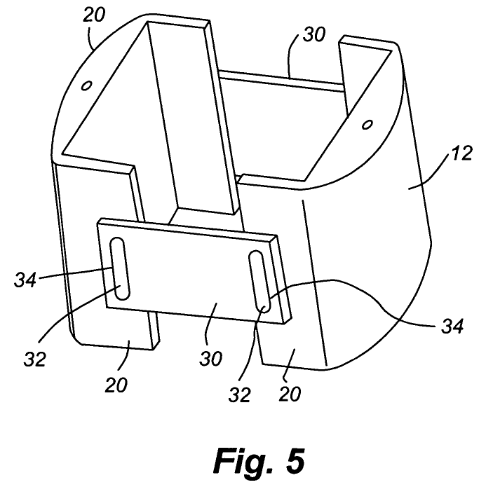

Referring now to FIG. 5, yet another embodiment of the present invention is shown herein. More specifically, the present invention may be used to enhance the performance of traditional rectangular prismatic batteries. Thus, this embodiment of the present invention is adapted for selective interconnection to a traditional prismatic battery. The user simply engages the compression compartments 20 to the ends of the traditional battery then selectively interconnect them to each other. Thus, internal pressure generated by the operation of the battery would be transferred to the compression compartment 20 similar to embodiments described above. Preferably, in one embodiment of the present invention, bosses 32 integrated into the sidewalls of the compression compartments are adapted to be interconnected with members of a predetermined length 30 to yield the desired compressibility of the cell elements. Alternatively, an adjustable interconnecting member 30 may be used to selectively alter the distance between the compression compartments 20 to accommodate various sizes of batteries.

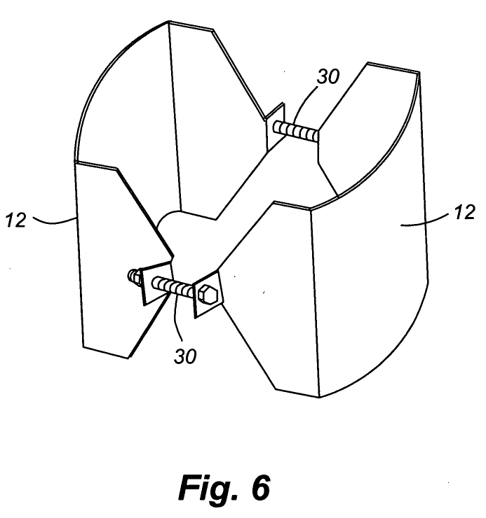

Referring now to FIG. 6, a shroud is depicted that may be used with the present invention to provide additional support to the compression compartment. The shroud's curved walls 12 are adapted to snugly fit on the curved walls of the compression compartment, using the same, or substantially similar radius of curvature on both surfaces to ensure a snug fit. Next, an interconnecting member 30 is used, to interconnect the two shroud halves. As appreciated by one skilled in the art, in one embodiment of the present invention a screw or bolt, or other similar interconnection means may be used. Sufficient tension may be added to the interconnecting member 30 to ensure that a snug fit is achieved. The resulting effect is that the shroud will help resist internal pressure increases thereby ensuring compression of the cell elements in the battery.

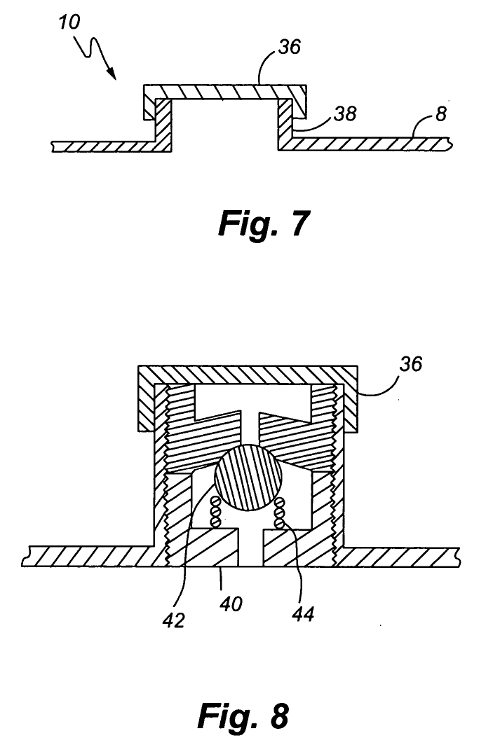

Referring now to FIG. 7, the filler aperture 10 receives incompressible fluid in one embodiment of the present invention is shown herein. It is necessary to avoid pre-stressing of the compression compartments, which would occur with the use of a plug that must be forced into the filler aperture after the compartment has been filled nearly full of liquid. Instead, the filler aperture is surrounded by a raised boss 38 molded as part of the plastic battery cover 8. The cap 36 is sealed after filling, either by the same heat-fusion process used typically to seal the main battery cover to the container, or by ultrasonic welding, thus being tamper proof. It must be kept in mind that the space inside the boss is part of the air space described above.

Referring now to FIG. 8, an alternative filler aperture 10, adapted to receive check valve 40, is shown, and is used when the liquid fill is pressurized. A conventional, commercial removable check valve is preferred, but FIG. 8 depicts an embodiment that utilizes a biasing means such as conical spring 44 applied to rubber ball 42 against an opening 52. The compression compartment liquid is introduced following attachment of the primary cover to the housing. The compartment is first filled with liquid with the check valve removed, allowing for proper air space size as described above. Subsequently, the check valve is attached and pressurized air is added in an amount that will provide the required, pre-determined pressure level. A cap 36 is then attached to seal the compartment.

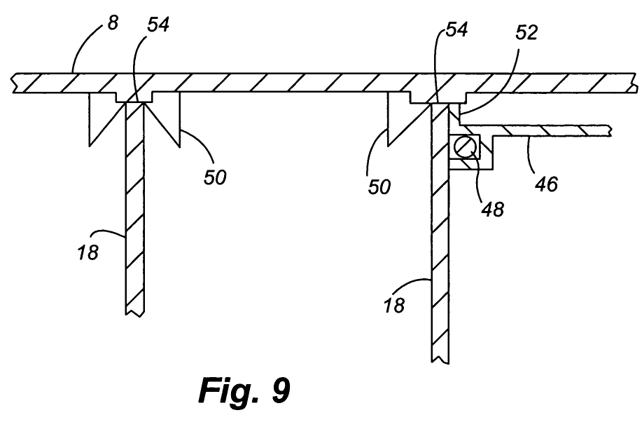

Referring now to FIG. 9, a sealing attachment for separate compression compartment covers is shown. This embodiment is utilized where the above-described, simple heat seal of the primary battery cover 8 is deemed inadequate to maintain a positive pressure in the compression compartment over an extended period of time. In this embodiment a rubber O-ring 48 provides the necessary seal. Also shown are triangular locating tabs 50 that are utilized to locate the partition walls to their mating positions on the cover 8. In one manufacturing sequence, the cell elements are first placed in their compartments. Then separate compression compartment covers 46, with O-rings 48 attached, are inserted in to the position shown. Ultrasonic spot welds 52 are employed to secure the retaining covers 46 during the liquid fill. Following the liquid fill step, and attachment of caps, the assembly of the battery is completed by interconnecting the primary cover 8 with preferably a heat seal 54. Alternatively, the primary cover 8, containing openings for the check valve fillers, may be interconnected prior to the liquid filling operation. It is noted that the combination of ultrasonic spot welds 52, together with the final heat seal 54 attachment of the primary cover 8, provides a strong resistance to the internal pressure of the compression compartments.

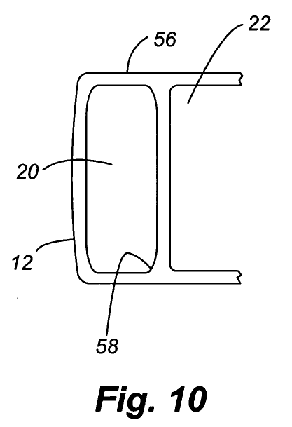

Referring now to FIG. 10, an alternate shape for the compression compartment is shown. The same cylindrical end wall 12 is utilized as before, however the total volume of the compartment has been increased by adding straight wall increments 56. An inner radiused corner 58, or fillet detail is also shown, which is the preferred embodiment when the O-ring seal is used, since the O-ring may not provide a leak-proof seal in a sharp corner.

While various embodiments of the present invention have been described in detail, it is apparent that modifications and abdications of those embodiments will occur to those skilled in the art. However, it is to be expressly understood that such modifications abdications are within the scope and spirit of the present invention, as set forth in the following claims.

What is claimed is:

1. A storage battery comprising:
a container having at least one cell compartment adapted for receiving an electrochemical cell element;
an electrochemical cell element situated in said cell compartment;
battery terminals in electrical communication with said cell element;
compression compartment positioned on at least one end of said at least one cell compartment, wherein said compression compartment includes an innermost wall facing said cell element and an outermost arcuate wall; and
a substantially incompressible filler material contained by said compression compartment, whereby forces acting upon said innermost wall of said compression compartment are transmitted generally through said filler material to said outermost arcuate wall, thereby substantially preventing said innermost wall from deflecting.

2. The storage battery of claim 1, wherein said incompressible filler material is comprised of at least one of a purified mineral oil, a salt solution, and a battery electrolyte.

3. The storage battery of claim 1, wherein said compression compartment is filled with liquid under a positive pressure sufficient to impart a substantially axial force onto said at least one cell compartment to compress said cell element situated therein.

4. The storage battery of claim 3, wherein the liquid is introduced into the compression compartment through a check valve, whereby said axial force is maintained subsequent to the filling of said compression compartment.

5. The storage battery of claim 1, wherein said compression compartment is partially filled with liquid, wherein the remaining volume is occupied by a gas that has been introduced to said compression compartment under positive pressure.

6. The storage battery of claim 1, wherein said outermost arcuate wall is generally in the shape of a right circular cylinder.

7. The storage battery of claim 1, wherein said compression compartment is selectively engaged to said at least one cell compartment.

8. The storage battery of claim 1, wherein said compression compartment further includes at least one stiffening member extending between said innermost wall and said outermost arcuate wall.

9. A shroud adapted for selective interconnection with a storage battery, comprising:
a left compression compartment that includes at least one interconnecting means;
a right compression compartment that includes at least one interconnecting means; and
at least one interconnecting device that selectively interconnects said interconnecting means of said left compression compartment and said right compression compartment, thereby adding additional strength along the longitudinal axis of the storage battery.

10. The shroud of claim 9, wherein said interconnecting means are bosses interconnected to said left compression compartment and said right compression compartment that selectively interconnect with corresponding slots on said at least one interconnecting device, wherein the distance between said left compression compartment and said right compression compartment accommodate the length of the storage battery.

11. The shroud of claim 9, wherein said left compression compartment and said right compression compartment are substantially hollow volumes that include an interior wall adapted to engage with the end wall of the storage battery and a generally arcuate wall interconnected to said interior wall.

12. The shroud of claim 11, wherein said arcuate walls of said left compression compartment and said right compression compartment employ a radius of curvature defined by a right circular cylinder.

13. The shroud of claim 9, wherein said left compression compartment and said right compression compartment are substantially filled with a substantially incompressible fluid.

14. The shroud of claim 13, wherein said substantially incompressible fluid comprises at least one of a purified mineral oil, a salt solution, and a battery electrolyte.

15. A storage battery housing, comprising:
a container having at least one cell compartment adapted for receiving an electrochemical cell element;
a leak-resistant compression compartment positioned at one end of said at least one cell compartment, wherein said compression compartment includes an innermost wall facing said cell element and an outermost arcuate wall; and
wherein said compression compartment is adapted to contain a substantially incompressible filler material, whereby forces acting upon said innermost wall of said compression compartment are transmitted generally through the filler material to said outermost arcuate wall, thereby substantially preventing said innermost wall from deflecting.

16. The storage battery housing of claim 15, wherein said compression compartment further includes a floor to define a volume, said volume being sealed a predetermined distance from said floor by a cover.

17. The storage battery housing of claim 16, wherein said cover is interconnected at least to said innermost wall with a heat weld.

18. The storage battery housing of claim 16, wherein said cover includes a groove adapted to receive a sealing device.

19. The storage battery housing of claim 15, wherein said compression compartment further includes two lateral walls positioned between said innermost wall and said outermost arcuate wall.

20. The storage battery housing of claim 19, wherein said innermost wall and said outermost arcuate wall are interconnected to said two lateral walls with fillets of a predetermined radius.

21. The storage battery housing of claim 15, wherein said outermost arcuate wall employs a radius of curvature defined by a right circular cylinder.
